(19) United States
(12) Patent Application Publication
(10) Pub. No.: US 2026/0264088 A1
(43) Pub. Date: Sep. 10, 2026

(54) ONE-PIECE COMPOSITE GRINDING ROLLER

(71) Applicant: Magotteaux International S.A., Vaux-sous-Chèvremont (BE)

(72) Inventors: Guillaume BRUEL, Angleur, Liège (BE); Benoît Clermont, Grivegnée, Liège (BE)

(21) Appl. No.: 19/159,247

(22) PCT Filed: Apr. 9, 2024
(86) PCT No.: PCT/EP2024/059597

§ 371 Date: Aug. 22, 2025

(30) Foreign Application Priority Data
Apr. 19, 2023 (EP) 23168749.2

(51) Int. Cl. B02C 15/00

(52) U.S. Cl. CPC B02C 15/005; B02C 2210/02

(57) ABSTRACT

A one-piece grinding roller for vertical-axis grinders is produced by casting in a metal mold in a foundry. The roller includes, on its periphery, a perforated reinforcing structure made up of ceramic inserts contiguously joined together. The contiguous assembly of the ceramic reinforcements is carried out along wavy lines.

### FIELD

The present disclosure relates to a composite wear component cast by casting a ferrous alloy. It relates more particularly to a one-piece grinding roller.

### BACKGROUND

Cast composite wearing components are well known to those skilled in the art. They are primarily cast-iron components which are locally reinforced in a targeted manner by ceramics of the alumina-zirconia type, or carbides, nitrides, borides or other intermetallic elements, on the faces most exposed to wear. These ceramics have studied geometries and are situated appropriately within the metal matrix.

The particular arrangement of the reinforcing structures specifically makes it possible to create hierarchical composites with a reinforcement that is differentiated according to the arrangement or the geometrical shape of the ceramic reinforcements which are composed generally of aggregates of grains which are infiltrable by the casting metal. In this way, it is possible to produce aggregates of granules measuring, on average, 3 to 8 mm with interstices of the order of 1 to 3 mm allowing the infiltration by the liquid cast iron during the casting. It is thus possible to form “cakes” or “wafers” in the form of perforated structures of the honeycomb type for example. These “inserts” are generally arranged in a studied manner inside a sand mold on the most stressed face of the wearing component. These “inserts” are called “padding”. When these cakes have been infiltrated individually, before being disposed, once cooled, in the casting mold, they are called bars.

The present disclosure aims to improve the wear resistance of grinding rollers for mills in general and in particular for what are referred to as vertical-axis mills. Vertical-axis mills are used, for example, for grinding coal, raw mix or cement clinker. They consist of a rotary track supporting rollers which are driven by the rotational movement of the track along the vertical axis (see FIG. 1). The material to be ground is introduced via a central feed path and falls onto the track, where it is crushed and ground by the rollers. This principle is illustrated in detail in FIG. 2. The ground material is then discharged by centrifugation to the periphery of the track and recovered in a blower with a cyclone allowing the material that is not yet sufficiently ground to be recycled. Various types of shapes of rollers are possible, frustoconical rollers and toric rollers being the most common.

Document WO98/15373 discloses a cast composite wearing component with a ceramic reinforcement in the form of a honeycomb and a ceramic based on alumina-zirconia.

Document WO2005/084809 discloses a grinding roller comprising multiple peripheral bars which are made of a material with high resistance to wear and are mechanically sealed in a casting matrix made of ductile material, said roller comprising zones subjected to high wear stress and zones subjected to low wear stress, the roller having on its peripheral face bars comprising a contiguous part in the most stressed zone and a non-contiguous part in the zone least stressed by wear, the gap in the non-contiguous part being filled by the ductile material of the casting matrix allowing mechanical sealing of the bars.

Document WO2018/069006 discloses a grinding roller for vertical-axis mills which is cast by casting a metal matrix, the roller comprising at its periphery a plurality of reinforcing inserts, of which certain portions of the peripheral surface of the same insert are situated at different distances from the periphery of the roller depending on the wear stresses.

Document WO 2021/160381 discloses a grinding roller where the zones subjected to wear are reinforced in a differentiated manner with ceramic inserts comprising blind holes and through-holes, the blind side of the blind holes being oriented on the side that is most stressed by wear.

### SUMMARY

The present disclosure includes a one-piece grinding roller reinforced by a perforated ceramic structure incorporated in the roller with a specific assembly of reinforcing elements that is possibly adapted to the wear stress by creating a differentiated perforation. It also discloses a method for manufacturing said roller. The present disclosure aims to provide a one-piece composite grinding roller with a ceramic reinforcement composed of a plurality of inserts of improved geometry, of which both the structure and the positioning are adapted to the wear stress. It aims in particular to eliminate the straight lines between the contiguous ceramic inserts, which constitute propagation initiators and preferred paths for wear.

The present disclosure discloses a one-piece grinding roller for vertical-axis mills which is cast by casting a metal matrix, said roller comprising at its periphery a perforated reinforcing structure consisting of a plurality of ceramic inserts assembled in a contiguous manner, the contiguous assembly of the ceramic reinforcements being produced along wavy lines.

Preferred embodiments of the present disclosure have at least one, or any appropriate combination, of the following features:
the reinforcing structure 2 comprises at least a first zone 21, which is the least perforated and the most exposed to wear, and at least a second zone 22, which is the most perforated and the least exposed to wear;
the first and second zones 21 and 22 of the plurality of ceramic inserts are formed by multiple superposed rings, said inserts being assembled in a staggered, contiguous manner along wavy lines;
the perforation of the first zone 21, which is the most exposed to wear, is formed by through-holes 3 of frustoconical shape with a diameter which progressively decreases toward the periphery of the roller or by a combination of through-holes 4 of any shape with blind holes whose blind side is located on the periphery side of the roller;
the perforation of the second zone 22, which is the least exposed to wear, is formed by through-holes 4 of any shape, preferably of cylindrical shape, and positioned in a perpendicular or inclined manner with respect to the surface at the periphery of the roller;
the plurality of inserts are assembled so as to form a frustoconical roller or a toric roller;
the amplitude (a) of the wavy lines represents between 2 and 20%, preferably between 5 and 15%, with respect to the length “L” of the ceramic insert;
the amplitude (A) of the wavy lines represents between 2 and 20%, preferably between 3 and 15%, with respect to the width “ [symbol] ” of the ceramic insert;
the composition of the ceramic of the reinforcing structure is selected from oxides, carbides, nitrides and borides;
the ceramic inserts comprise an aggregate of ceramic-metal composite grains in which micrometric ceramic particles are cemented in a metal binder, the composite grains having an average size D₅₀ of 2 to 8 mm, preferably of 3 to 6 mm, determined by sieving with a square mesh or by a Retsch Camsizer according to Standard 13322-2:2006;
the ceramic-metal composite grains comprise titanium carbide of an average size D₅₀ of between 3 and 20 μm, preferably between 5 and 15 μm, cemented in a metal binder, the particle size being measurable by laser diffraction using MIE theory according to the instructions provided in Standard ISO 13320:2020 using, for example, a Malvern Mastersizer 2000 and setting a refractive index to 3 and an absorption index to 1. The obscuration should be in a range between 10 and 15% and the weighted residual less than 1%;
the composition of the ceramic of the reinforcing structure of the first zone 21 is different from the composition of the ceramic of the second zone 22.

The present disclosure also discloses a method for producing a grinding roller according to the present disclosure, comprising the following steps:
provision of a mold for the production of a one-piece grinding roller by casting a ferrous alloy;
positioning of a reinforcing structure composed of a plurality of ceramic inserts which are assembled in a contiguous manner along wavy lines, the inserts being in the form of perforated aggregates of millimetric granules, the aggregate being permeable and therefore infiltrable;
infiltration of the insert by the liquid ferrous alloy;
cooling and demolding of the grinding roller.

The method according to the present disclosure preferably has at least one, or any appropriate combination, of the following features:
the ferrous alloy comprises steel or cast iron;
the reinforcing structure comprises at least a first zone 21, which is the least perforated and the most exposed to wear, and at least a second zone 22, which is the most perforated and the least exposed to wear;
the infiltrable aggregates of millimetric ceramic granules used for the grinding roller inserts are selected from the following compositions:
   alumina-zirconia in proportions of 90/10 to 10/90, the zirconia possibly being stabilized with yttria;
   powdered carbon and titanium optionally comprising iron powder as moderator and precursors of a self-propagating thermal synthesis (SHS) reaction initiated by the casting of the ferrous alloy;
   ceramic-metal composites of titanium carbide cemented in a metal binder.

### BRIEF DESCRIPTION OF THE DRAWINGS

In the annotated figures below, the inserts are shown schematically. In reality, these ceramic inserts are infiltrable three-dimensional structures formed of permeable aggregates such as for example agglomerates of millimetric grains (with an average size of 2 to 8 mm, preferably 3 to 6 mm) aggregated by an adhesive with millimetric interstices which are infiltrable by the casting metal.

For the sake of simplicity, the figures only show the contour of these inserts placed in the reinforced parts of the grinding roller.

FIG. 1 shows an example of a vertical-axis mill equipped with frustoconical grinding rollers pressing against and rotating on a rotary table fed with ore to be ground.

FIG. 2 shows the principle of grinding by a frustoconical grinding roller.

FIG. 3 shows a grinding roller produced with bars which are reinforced by ceramics according to the prior art WO2005/084809. In this case, a plurality of ceramic inserts in the form of a honeycomb are infiltrated individually so as to form bars before being disposed, once cooled, in a mold making sure to maintain a distance between each individual reinforcing element (non-contiguous assembly) in order to allow the casting metal to penetrate between the individual elements and ensure sealing of the assembly in the cast roller.

FIG. 4a shows a bar consisting of a metal matrix incorporating a ceramic insert in the form of a honeycomb. FIG. 4b shows a detail of the assembly of the bars before the casting of the grinding roller.

FIG. 5 shows an image of a frustoconical grinding roller which is heavily worn on its lower part. It is a grinding roller according to the prior art and produced according to the techniques shown in FIGS. 3, 4a and 4b. Seen therein is a ceramic structure in the form of a honeycomb highlighted through a heavily eroded metal matrix. The spaces left between the individual bars (straight furrows) are also heavily eroded.

FIG. 6 shows an image of a toric grinding roller which has a significant level of wear. It has been produced according to the prior art WO2005/084809 by disposing infiltrated and cooled bars in a mold, maintaining a distance between the bars so as to ensure the sealing of the bars in the roller.

FIG. 7a shows a one-piece grinding roller of toric shape according to the present disclosure. FIG. 7b only shows the assembly of the corresponding perforated inserts, in which the inserts are assembled on a single ring in a contiguous manner and along a wavy line.

FIG. 8a shows a one-piece grinding roller of toric shape according to the present disclosure. FIG. 8b only shows the assembly of the corresponding perforated inserts, in which the inserts are assembled on two superposed rings in a staggered, contiguous manner along a wavy line.

FIG. 9a shows a one-piece grinding roller of frustoconical shape according to the present disclosure. FIG. 9b only shows the assembly of the corresponding perforated inserts, in which the inserts are assembled on a single ring in a contiguous manner along a wavy line.

FIG. 10 shows a one-piece frustoconical grinding roller according to the present disclosure that is similar to the one in FIG. 9a, a plurality of perforated ceramic inserts being disposed in a contiguous manner along a wavy line. However, shown therein are two types of openings (cells) with a differentiated proportion of perforation adapted to the wear stress for a specific use. The perforated inserts show two zones 21 and 22. The zone 21, which is the most exposed to wear, has a limited degree of perforation with conical holes disposed in the part which is subjected to the most wear stress, and a conicity of which the diameter changes from the inside of the roller to the outer surface of the roller by decreasing. The zone 22, which is subjected to the least wear stress, has a greater proportion of perforation and comprises cylindrical holes perpendicular to the grinding surface. The holes may also form an angle with the normal to the peripheral surface.

FIG. 11a shows a one-piece toric grinding roller according to the present disclosure, a plurality of perforated ceramic inserts being disposed in a contiguous manner along a wavy line. Also seen therein are two types of openings with a differentiated proportion of perforation adapted depending on a specific wear stress. In this case, the perforated inserts also show two zones 21 and 22. FIG. 11b shows solely the plurality of assembled inserts before the casting of the grinding roller. It is noted here that the assemblies of the inserts are not only contiguous but the elements have complementary shapes allowing them to be assembled perfectly with their neighbors. An assembly according to a wavy shape has been selected so as to avoid straight lines which constitute a preferred initiator and a preferred path for wear. Once such wear has been initiated, it continues to propagate very easily along a straight line, and lines which are wavy to a more or less pronounced extent make it possible to slow down or even obstruct this phenomenon. Testing has furthermore shown that a simple curved contiguous line of assembly with low amplitude and without waves, although being more prone to propagation of wear paths than the straight contiguous line, only provided an intermediate result between the straight line and the wavy contiguous line.

FIGS. 12 and 13 show other possibilities for assembling inserts according to the present disclosure. The inserts may be dedicated to the zones 21 and 22 and form multiple superposed rings with possibly different dimensions. When the inserts are dedicated to the zones 21 and 22 with high and low wear stress, respectively, the staggered arrangement is preferred so as to as much as possible prevent the propagation of wear along a continuous line. This figure also shows in detail significant differences in perforation between the zones 21 and 22 with frustoconical holes 3 and cylindrical holes 4 as an example (detail not shown).

FIGS. 14a and 14b respectively show a large toric grinding roller once cast and an assembly of its corresponding inserts. Two distinct zones 21 and 22 adapted to different stresses are again distinguished therein. The inserts are arranged according to two superposed and staggered rings. The grinding roller may be slightly inclined (tilted) on the rotary table, thus necessitating such a configuration.

FIGS. 15a and 15b respectively show an assembly of inserts for a toric grinding roller and the grinding roller once cast. It is in this case a very large roller (18 tons and 3 m in diameter). Two distinct zones 21 and 22 adapted to different stresses are again distinguished therein. The inserts are arranged according to three superposed and staggered rings. The high-stress zones are disposed on either side of a zone with lower stress. This symmetrical arrangement makes it possible to use slightly inclined grinding rollers on the rotary table alternately on the two sides. Once one side has been worn, the roller can be turned around.

FIG. 16 shows a reinforcing insert with its length “L” and its width “ [symbol] ” and the amplitude of the waves “A” over its width “ [symbol] ” and how to measure them.

FIG. 17 shows a staggered assembly of different inserts, in which it can be seen that the amplitude of the wave is not necessarily the same over one and the same line of assembly. The amplitude is measured in terms of absolute value between a minimum and a maximum of the wave, “A” or “A” with respect to the width “ [symbol] ” or “a” with respect to the length “L” or “L” of the assembled inserts. The amplitudes “A” and “a” are evaluated respectively as a percentage with respect to the width “ [symbol] ” and to the length “L”.

FIG. 18 shows a method for measuring the wear profile of a toric grinding roller using rods for comparison with a surface of a new grinding roller.

FIG. 19 shows a wear profile of a frustoconical grinding roller with a thicker arrow showing the position of the maximum wear which is a determining factor for the replacement of the roller.

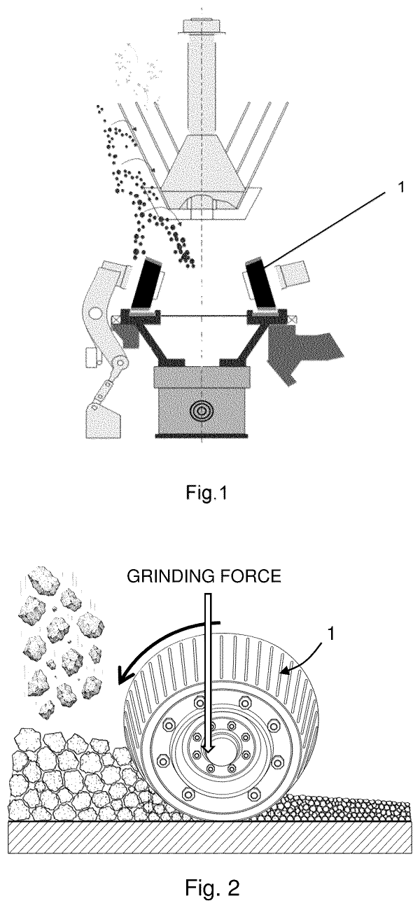

### LIST OF THE REFERENCE SYMBOLS

1: one-piece grinding roller
2: ceramic inserts
21: first zone of the ceramic inserts which is placed on the side most exposed to wear
22: second zone of the ceramic inserts which is the least exposed to wear
3: example of frustoconical openings in the ceramic inserts positioned on the most stressed face of the grinding roller
4: example of cylindrical openings in the ceramic inserts positioned on the least stressed face of the grinding roller

### DETAILED DESCRIPTION

Cast wearing components are widespread in the mining and cement industries for the grinding of rocks and ores. Among those are the tables of vertical compressive mills and their grinding rollers in general and the frustoconical and toric grinding rollers in particular which illustrate the present disclosure.

In order to increase the wear resistance of the grinding rollers, ferrous alloys of the cast iron or steel type are combined with the hardness of a ceramic material (such as for example carbides, nitrides, oxides of various types, etc.), which have good resistance to wear.

Combining these two types of material is, however, not easy because they have very different expansion coefficients that may generate microcracks during the cooling of the components and negate via the potential defects thereof this synergy effect in a composite wearing component.

Another difficulty resides in the problem of complete infiltration of the ceramic insert by the liquid cast iron which tends to cool on contact therewith, thus counteracting satisfactory infiltration.

Numerous configurations of ceramic inserts have been tried by manufacturers. The most popular ceramic insert is a “honeycomb” shape which is relatively easy to infiltrate, such as those cited in the prior art WO98/15373.

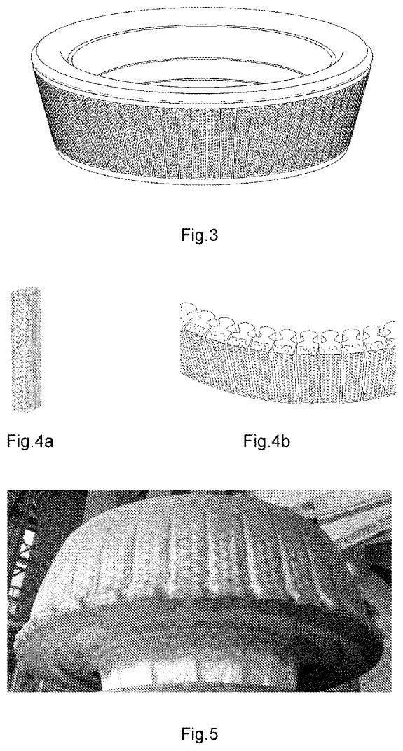

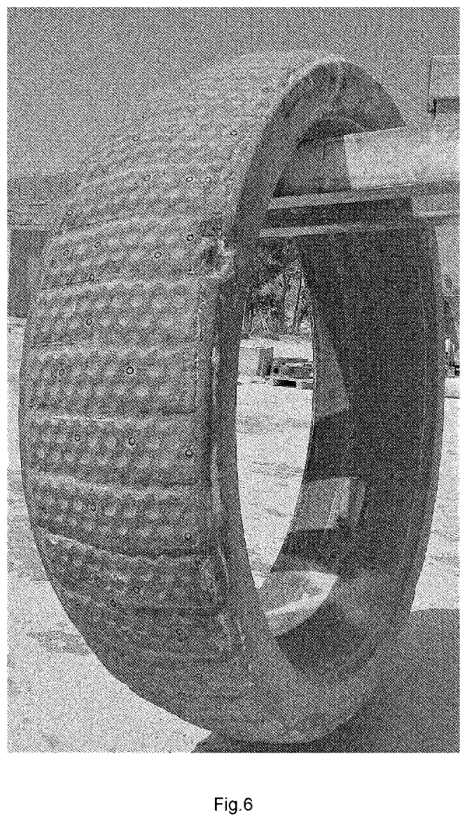

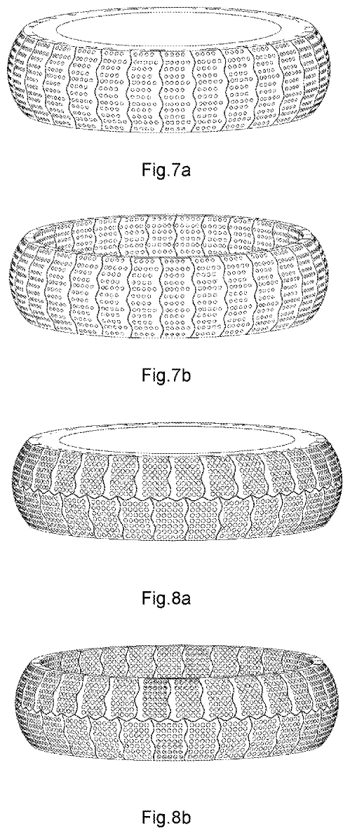

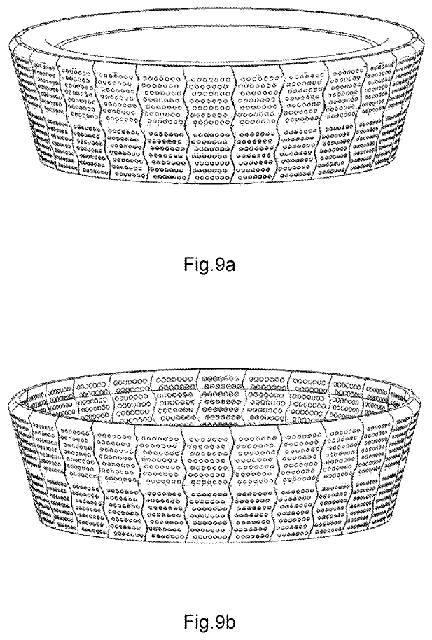

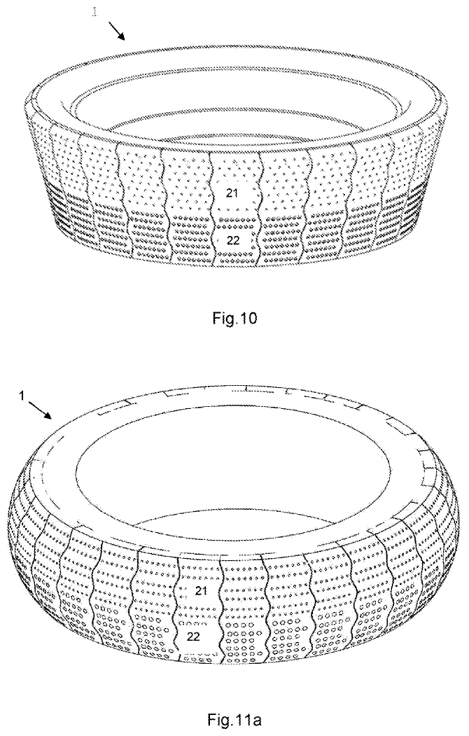

Ceramic reinforcements are generally introduced in the form of bars, therefore in the form of an insert in which the interstices have already been infiltrated by liquid cast iron, and cooled before being reintroduced into a mold for casting the wearing part as a single block desired to be obtained. This technology is illustrated in FIGS. 3 to 5 of the present document and is the subject of publication WO2005/084809.

There is a lot of skill involved in the production of a ceramic insert because the latter has to have a permeable structure so as to be infiltrated by the liquid cast iron, the level of permeability being a determining factor, and this has led to a series of technologies for manufacturing powder agglomerates (aggregates) in the form of aggregated grains of a few millimeters which are then assembled into a “cake/wafer” structure in a mold and compacted by vibration. Once they have left the mold, these inserts always have irregular interstices of the order of 1 to 5 mm.

There are many possible compositions for the production of a ceramic insert which can be used in a reinforced grinding roller according to the present disclosure. In a non-exhaustive list, mention may for example be made of:
alumina-zirconia 10/90 to 90/10, with or without yttria stabilization, in the form of millimetric granules assembled into aggregates by means of an inorganic adhesive in a structure that is permeable to the molten metal and therefore infiltrable by conventional casting;
particles resulting from ground or sintered metal-ceramic composites from mixtures of powders based on carbides, nitrides, borides or intermetallic elements, cemented in a metal binder before being agglomerated into a structure that is permeable and therefore infiltrable by a molten ferrous alloy;
ceramics formed by self-propagating exothermic synthesis (SHS) such as for example titanium carbide from carbon and titanium powders, possibly mixed with a powder for moderating the reaction such as for example iron powder, which may be in the form of agglomerated millimetric grains with millimetric interstices. The reaction between the carbon and the titanium being initiated by the casting of the ferrous alloy;
   Holding the insert in the mold during the casting also requires a certain level of skill acquired by manufacturers over the years.

The configuration and positioning of the ceramic inserts within a one-piece composite grinding roller has been the subject of much research which has always concluded that the results regarding speed of wear obtained during tests are relatively unpredictable because they are dependent on the specific application, that is to say on the type of machine used and on the type of rocks to be ground.

The situation is made even more complex by the fact that, during the wear phenomenon, the geometry of the grinding roller changes and the zones that are only slightly stressed at the beginning may become much more so as the state of advance of the wear progresses. It is therefore often necessary to make a compromise on the structure of the insert allowing the short-term and long-term wear to be reconciled, these two notions possibly varying considerably from one specific case to another.

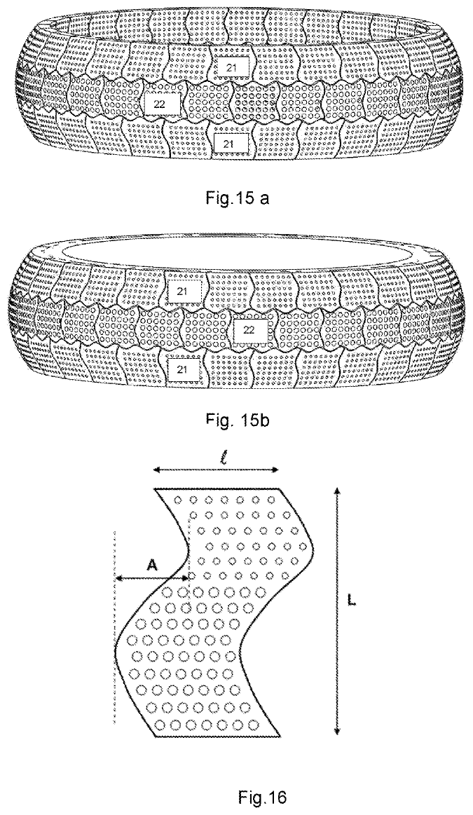

The inventors of the grinding roller according to the present disclosure have now produced a reinforcing structure comprising a plurality of ceramic inserts addressing this compromise. This reinforcing structure is adapted to the final shape of the roller and is for example of frustoconical or toric overall shape and comprises at its periphery an assembly of ceramic inserts which may be in different forms such as for example a side-by-side, therefore contiguous, assembly of inserts having approximately the same dimension as the grinding roller or a superposition of two or more “rings” of ceramic inserts along wavy lines. The assembly on one or more rings is largely dependent on the final size of the roller insofar as there is still a limit of feasibility for an insert for reasons of handling by an operator (mass, volume, friability). Thus, a roller weighing a ton may require only one ring with a limited number of inserts to be assembled whereas a roller weighing >15 tons will require at least 2 or 3 rings with numerous superposed inserts. (See FIG. 15b for example).

Depending on the stresses for specific uses, it is possible to envision a differentiated perforation depending on the position of the insert in the roller. It is for example possible to envision a different proportion of perforation depending on whether the side most stressed, zone 21, or the side least stressed, zone 22, by wear is concerned. An example of assembly of a ring of inserts of this type for a toric grinding roller is shown in FIG. 11a, and an example of two superposed rings is shown in FIG. 14a. Three rings of superposed inserts are shown 15b

In order to avoid the propagation of wear along a predetermined line, the superposed inserts are preferably assembled in a staggered manner.

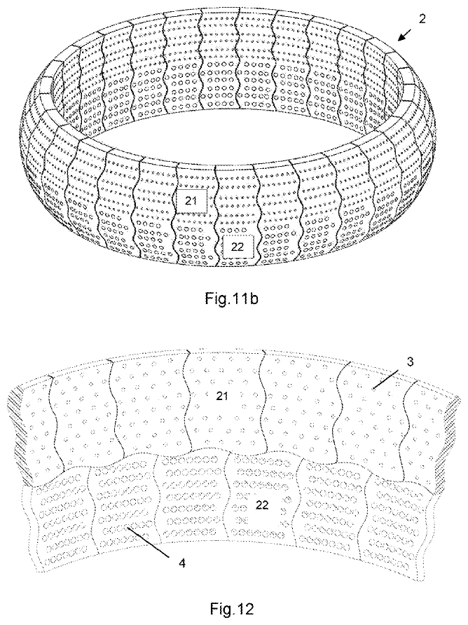

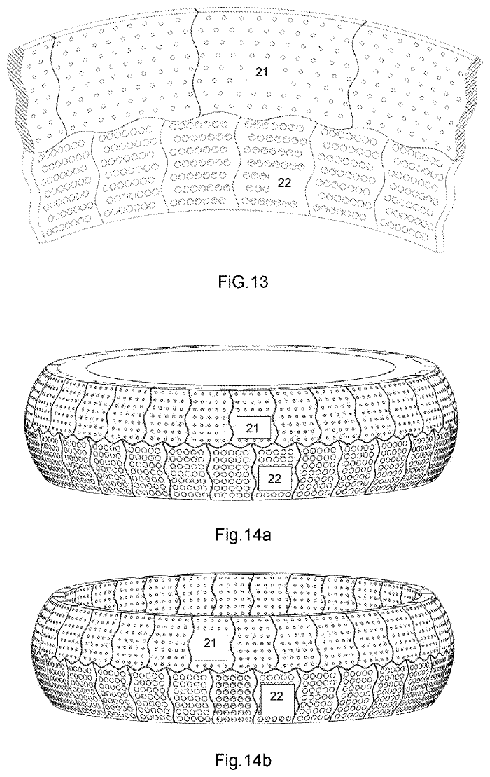

The perforated ceramic structures have openings of generally any shape. The openings provided in the structure of the insert have a diameter generally between 1 and 10 cm, preferably between 1 and 8 cm and particularly preferably between 2 and 4 cm. When the perforation is differentiated within one and the same grinding roller, the peripheral zone most exposed to wear 21, the holes preferably have a frustoconical shape 3 or are combined with blind holes. The most exposed zone may also comprise a skillful combination of blind holes and through-holes. When blind holes are used, the blind side is placed on the side which is most stressed by wear. When frustoconical openings 3 are used, the opening will progressively narrow toward the outer surface most exposed to wear. In the least exposed and most perforated zone 22, the holes have any shape, but the cylindrical shape will be preferred. (See FIG. 12).

The inventors have furthermore observed that straight lines or even slightly curved lines constituted significant initiators for the wear of a grinding roller. The wear propagating much more rapidly in a straight line because it does not meet any obstacles once initiated.

In order to alleviate this phenomenon, the inventors have eliminated the spaces between the inserts, of which the technological change in their manufacture now enables better infiltration. The assemblies of inserts according to the present disclosure are therefore contiguous and formed along a wavy line making it possible to avoid the initiation and the propagation of wear in a straight line. All forms of waves are of course conceivable, but for reasons of logistics preference is given to components which all have the same shape, having a concavo-convex side allowing a perfectly contiguous complementary assembly.

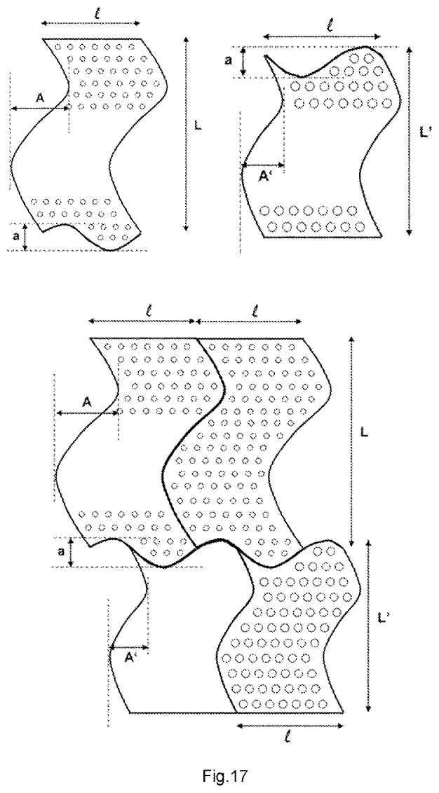

The amplitude of the wave and how it is measured is shown in FIGS. 16 and 17. In these figures, the amplitude of the waves is exaggerated for the purposes of the demonstration.

### EXAMPLES

Tests were conducted on different rollers according to the present disclosure on a vertical rotary mill of two different types suitable for the rollers to be tested. In order to neutralize the variable due to the influence of the composition of the ceramic on the wear, the same ceramic was used for all of the tests. It is millimetric grains of a metal-ceramic composite of the titanium carbide type cemented in a metal binder of the manganese steel type. These grains of an average dimension of around 5 mm were compacted to form perforated inserts of a thickness of around 50 mm which were used for all of the tests.

For the purposes of the test, the configurations of inserts distributed on multiple rings were realized, whereas, on a roller weighing a ton for example, multiple rings would not necessarily be required. The inventors nevertheless wanted to test the behavior of the rollers according to the present disclosure when the inserts had been configured in multiple superposed rings with a staggered positioning.

Each of the 2 frustoconical rollers was tested in parallel with a reference roller for 500 hours and the wear was extrapolated to 1000 hours. For each of the 3 toric roller tests, two rollers were disposed in alternation with two reference rollers and were rotated for 1000 hours. The tests were performed continuously.

The test conditions are summarized in the table below.

| Ground material | Coal of the lignite type | | Silico-calcareous ore | |
|---|---|---|---|---|
| Mill type | Polysius RM25/12 (type 1) | | Loesche LM15.2 (type 2) | |
| Roller type | Toric | | Frustoconical | |
| Number of rollers | 4 | | 2 | |
| on the mill | | | | |
| Roller mass (T) | 1.4 | | 1 | |
| External size | 130 × 33 | cm | 120/104 × 33 | cm |
| Flow rate (T/h) | 27-30 | | 25 | |
| Test duration | 1000 | hours | 500 | hours |

| | | |
|---|---|---|
| Positioning of | 2 reference rollers and 2 | 1 reference roller and a |
| the rollers | rollers according to the | roller according to the |
| | present disclosure in | present disclosure on the |
| | alternation on the same | same mill |
| | mill | |

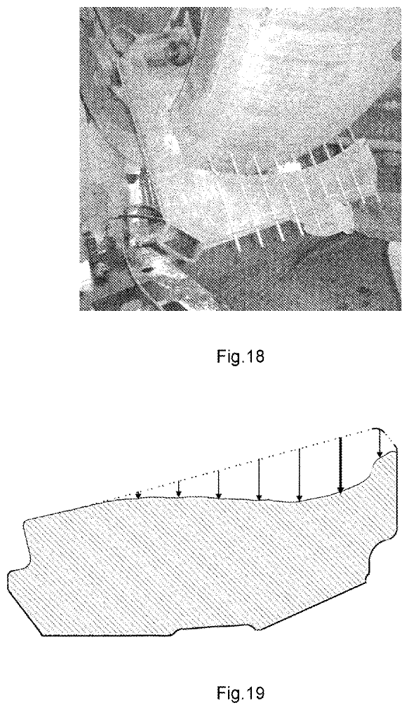

The roller wear may be determined at the beginning from measurements of profiles, along generatrices, by means of a template pressing against surfaces that are not subjected to wear. The distance between the surface of the roller and the template is noted at multiple points along the template on a representative number of points on the contour of the roller. (See FIG. 18). These measurements are then compared with the distances noted on a new roller. An average wear profile is determined providing information about the geometry of the wear which will be able to be exploited by the manufacturer.

The measurement of the wear selected for the comparison of the performance properties of the rollers is, however, the depth of maximum wear on the roller, which is critical to its replacement. It is this maximum wear which will be used in the table below for the performance measurements. The grinding rollers produced with bars according to WO2005/084809 and shown in FIGS. 3, 4 and 5 are used as reference comparative frustoconical and toric rollers. These reference rollers are each time combined with rollers according to the present disclosure on the same mill during the testing. In the latter, the wear is measured above the bars and not between the bars on the heavily worn ductile matrix.

Tests on the Mill of Type 1 with Toric Rollers
Tests on the Mill of Type 2 with Frustoconical Rollers

### Results

| | Number of | | A/ [symbol] | a/L | Wear | Improvement |
|---|---|---|---|---|---|---|
| Examples | rings | Cells (mm) | % | % | mm/1000 h | coefficient |
| Reference | 1 | 23 | — | — | 11 | 1.00 |
| 1 | 1 | 23 | 14 | | 9.9 | 1.11 |
| 2 | 1 | 23 and 13 | 12 | | 8.8 | 1.25 |
| 3 | 2* | 23 and 13 | 13 | 12 | 9.2 | 1.19 |
| Reference | | 23 | | | 37 | 1.00 |
| 4 | 1 | 23 and 13 | 4 | | 29.1 | 1.27 |
| 5 | 2* | 23 and 13 | 9 | 5 | 33.6 | 1.10 |

*the inserts are assembled in a staggered manner

### Interpretation of the Results

With respect to the reference toric and frustoconical grinding rollers produced with bars according to WO2005/084809, all of the grinding rollers according to the present disclosure exhibit an improvement in wear performance. This improvement is between 10 and 27%, which is significant.

The rollers having a differentiated perforation depending on the wear stress with zones 21 and 22 (Examples 2 and 4 with cells of 13 and 23 mm) exhibit better performance properties when the reinforcing insert consists of a single ring of assembly with a minimum of join lines.

The rollers comprising multiple staggered superposed rings and a differentiated perforation exhibit reduced performance due to the multiplication of the number of inserts and therefore of join lines which will be necessary for grinding rollers of large dimensions.

The non-differentiated perforation, without specific zones 21 and 22, also allows an improvement in performance of 11% on the toric grinding roller.

1. A one-piece grinding roller for vertical-axis mills, the grinding roller comprising:
a cast metal matrix; and
a perforated reinforcing structure disposed at a periphery of the roller and consisting of a plurality of contiguous ceramic inserts;
wherein the plurality of contiguous ceramic inserts are arranged along wavy lines.

2. The one-piece grinding roller as claimed in claim 1, the perforated reinforcing structure comprising at least a first zone being the least perforated and the most exposed to wear, and at least a second zone, being the most perforated and the least exposed to wear.

3. The roller of claim 2, wherein the first and second zones of the plurality of ceramic inserts are formed by multiple superposed rings, the inserts being assembled in a staggered, contiguous manner along the wavy lines.

4. The roller of claim 2, wherein the perforation of the first zone is formed by through-holes having a frustoconical shape with a diameter progressively decreasing toward the periphery of the roller.

5. The roller of claim 2, wherein the perforation of the second zone is formed by through-holes oriented in a perpendicular or inclined manner with respect to the peripheral surface of the roller.

6. The roller of claim 1, wherein the plurality of contiguous ceramic inserts form a frustoconical roller or a toric roller.

7. The roller of claim 1, wherein an amplitude of the wavy lines represents 2% to 20% of a length of the ceramic insert.

8. The roller of claim 1, wherein an amplitude of the wavy lines represents 2% to 20% of a width of the ceramic insert.

9. The roller of claim 1, wherein a composition of the ceramic of the reinforcing structure is selected from the list consisting of oxides, carbides, nitrides, and borides.

10. The roller of claim 1, wherein the ceramic inserts comprise an aggregate of ceramic-metal composite grains in which micrometric ceramic particles are cemented in a metal binder, the composite grains having an average size D₅₀ of 2 to 8 mm, determined by sieving.

11. The roller of claim 10, wherein the grains comprise titanium carbide of an average size D₅₀ of 3 to 20 μm.

12. The roller of claim 2, wherein a composition of the ceramic of the reinforcing structure of the first zone is different from a composition of the ceramic of the second zone.

13. A method for producing the grinding roller of claim 1, the method comprising:
providing a mold for producing the one-piece grinding roller by casting a ferrous alloy;
positioning the reinforcing structure by assembling the plurality of ceramic inserts in a contiguous manner along wavy lines, the inserts being in the form of perforated aggregates of millimetric granules, the perforated aggregates being permeable, such that the perforated aggregates are infiltrable by a ferrous casting alloy;
infiltrating the insert by the ferrous alloy in liquid form; and
cooling and demolding the grinding roller.

14. The method as claimed in claim 13, wherein the ferrous alloy comprises steel or cast iron.

15. The method as claimed in claim 13, wherein the reinforcing structure comprises at least a first zone being the least perforated and the most exposed to wear and at least a second zone being the most perforated and the least exposed to wear.

16. The method as claimed in claim 13, wherein a composition of the infiltrable aggregates of millimetric ceramic granules used for the grinding roller inserts are selected from the following list:
alumina-zirconia in proportions of 90/10 to 10/90;
powdered carbon and titanium optionally comprising iron powder as moderator and precursors of a self-propagating thermal synthesis (SHS) reaction initiated by the casting of the ferrous alloy;
ceramic-metal composites of titanium carbide cemented in a metal binder.

17. The method of claim 16, wherein the composition is alumina-zirconia and the zirconia is stabilized with yttria.

18. The roller of claim 2, wherein the perforation of the first zone is formed by a combination of through-holes of any shape and blind holes having blind sides on the periphery side of the roller.

19. The roller of claim 5, wherein the through-holes are cylindrical.
